(19) United States
(12) Patent Application Publication
(10) Pub. No.: US 2023/0267516 A1
(43) Pub. Date: Aug. 24, 2023

(54) System and method for providing customized toll pricing

(71) Applicants: Maneesh Mahlawat, MOUNTAIN VIEW, CA (US); Kirti Mahlawat, MOUNTAIN VIEW, CA (US); Mohit Bahadur Singh, Milpitas, CA (US); Venkatesh Nellore, Tirupati (IN)

(72) Inventors: Maneesh Mahlawat, MOUNTAIN VIEW, CA (US); Kirti Mahlawat, MOUNTAIN VIEW, CA (US); Mohit Bahadur Singh, Milpitas, CA (US); Venkatesh Nellore, Tirupati (IN)

(73) Assignee: Mapup Inc, Sunnyvale, CA (US)

(21) Appl. No.: 17/679,095

(22) Filed: Feb. 24, 2022

(51) Int. Cl. G06Q 30/02; H04W 4/44

(52) U.S. Cl. CPC G06Q 30/0284; G06Q 30/0207; H04W 4/44

(57) ABSTRACT

A method performed by a server for providing incentives on toll prices to one or more users of a plurality of users. The method includes receiving a first plurality of traffic inputs, a second plurality of toll inputs, and a third plurality of user associated inputs. The method further includes identifying one or more decision areas on the road network based on the first plurality of traffic inputs and second plurality of toll inputs. Thereafter, the method includes determining one or more users approaching the one or more decision areas, based on the geo-locations of the plurality of users, and then determining a probability of the one or more users taking the at least one toll road. In response to the determination, the method includes calculating incentives on the toll prices, and transmitting the incentive to the one or more users at respective one or more decision areas.

### FIELD OF THE INVENTION

The present invention relates to a system and method for providing customized toll pricing to users, and more specifically to a system and method for providing customized toll pricing to users based on traffic conditions at one or more specific locations on a road network and users' profile.

### BACKGROUND OF THE INVENTION

A toll road, also known as turnpike or tollway, is a road for which a fee is charged to a commuter, by tolling agencies, for traveling through the road. Similarly, a fee is charged to commuters for traveling through certain highways, tunnels, or bridges. Traditionally this fee is usually charged to generate funds for repayment of toll revenue bonds used to finance constructions and/or operation of toll roads. In general, the toll fee is collected manually by tolling agencies, or by electronic toll collection systems. In the past several years, tolls have also been collected to manage traffic demand on congested travel corridors. These new toll roads—express lanes, managed lanes, or high occupancy toll lanes (HOT)—help meet revenue shortfalls as well as manage traffic congestion.

Typically, the tolling agencies increase the toll fee when the traffic on toll road increases, in order to divert traffic away from the toll road to non-tolled road segments. Similarly, the tolling agency may decrease the toll fee as the traffic on the toll road decreases, so that more vehicles take the toll road to generate more funds/maintain revenue from the toll road and to ensure optimum utilization of the toll road. In other words, the toll fee is increased or decreased to regulate traffic on the toll road, maintain revenues for the tolling agencies, and to ensure that the toll road is not under or over utilized.

Although the manual collection of toll fee is a robust way of charging toll, it requires installation of toll plazas on different toll roads, and it slows down the movement of vehicles on the toll road. Thus, a lot of toll agencies are nowadays opting for an electronic toll collection system that collects the toll fee using a transponder installed on a user's vehicle. Using the electronic toll collection system, the tolling agencies automatically detect if the user has used a toll road (e.g. using cameras or sensors installed on the toll road that communicate with the transponder of user's vehicle), and charge them the toll using their bank account details associated with the transponder.

While the electronic toll collection systems are better than the manual toll collection systems, it is seen that usually there exists a lag between a user passing through a toll plaza and the conveying of the toll collection information to the user. In some cases, it might take up to a month for the user to know their toll fee information. In fact, in some scenarios, the user may not even be aware that he passed through the toll road, and hence, may not be aware of his outstanding tolls. Also, since the collection system is electronic (without any manual involvement), few users are not aware where to go and pay for their outstanding tolls. All these issues lead to loss or delay of revenues for the tolling agencies, and inconvenience for the users.

Further, some users may not have a transponder installed on their vehicles. Due to this, the electronic toll collection system may not work and the tolling agencies may need to collect the toll fee manually from those users. In other words, a single tolling agency may need to collect the toll fee using different means from different users. In addition, all the tolling agencies, even within the same geographical area such as a city, do not use a single approach to collect tolls, and hence, the users need to make payments to different agencies in different ways, which creates a lot of confusion and inconvenience for the users. Furthermore, in some scenarios, the tolling agencies fail to detect that a driver has passed through a toll plaza (missed toll). For example, in some cases, the transponder may not be read correctly by the electronic toll systems or the license plate may not be captured by the cameras installed on the toll road. This too leads to loss of revenue for the tolling agencies.

Thus, there is a need for a system and method for efficiently collecting toll from users, ensuring optimal utilization of toll roads, reducing inconvenience for the users, and maximizing revenue generation for toll agencies.

### SUMMARY OF THE INVENTION

The present invention is directed towards a platform for providing incentives on toll prices to one or more users of a plurality of users. The platform may include a transceiver that may be configured to receive a first plurality of traffic inputs that comprises one or more of: historical traffic information of a road network, real time traffic information of the road network, information associated with real time events, and throughput of one or more toll roads on the road network. The transceiver may be further configured to receive a second plurality of toll inputs that comprises one or more of: real time and historical toll prices for the one or more toll roads on the road network, historical incentives on the toll prices offered at the one or more toll roads to the plurality of users. The transceiver may be further configured to receive a third plurality of user associated inputs that comprises geo-locations of the plurality of users and one or more of: historical travel and driving patterns of the plurality of users on the road network, information on at least one of historical toll and incentives accepted by the plurality of users, user demographics, decision history of the plurality of users taking the one or more toll roads with or without incentives on toll prices, and an information of socio-economic status of the plurality of users. The platform may include a processor that may be configured to identify one or more decision areas in real time on the road network based on the first plurality of traffic inputs. The decision areas are regions on the road network from where the plurality of users can enter at least one toll road of the one or more toll roads. The processor may be further configured to determine one or more users, of the plurality of users, approaching the one or more decision areas, based on the geo-locations of the plurality of users. Based on the first plurality of traffic inputs, the second plurality of toll inputs, and the third plurality of user associated inputs, the processor may be further configured to determine a probability of the one or more users taking the at least one toll road. Thereafter, the processor may be further configured to calculate incentives on the toll prices to be offered to the one or more users to modify the probability of the one or more users taking the at least one toll road. The incentives may be calculated based on the first plurality of traffic inputs, the second plurality of the toll inputs, and the third plurality of user associated inputs. The transceiver may be further configured to transmit the calculated incentives to the one or more users when the one or more users are at the respective one or more decision areas.

In accordance with an embodiment of the present invention, the incentives may include at least one of increasing the toll prices, decreasing the toll prices, providing round trip discounts, and providing non-monetary benefits.

In accordance with an embodiment of the present invention, to identify the one or more decision areas, the processor may be configured to determine of traffic source and traffic sink based on the first plurality of traffic inputs; determine a plurality of entrance points, exit points, and toll road locations from where traffic from the traffic source and traffic sink meet the one or more toll roads; determine congestion levels at the plurality of entrance points, exit points and the toll road locations based on the first plurality of traffic inputs; and select one or more entrance points, exit points and toll road locations which fulfill a predetermined criteria, as the one or more decision areas.

In accordance with an embodiment of the present invention, the processor may be further configured to dynamically update the one or more decision areas based on the first plurality of traffic inputs and driving patterns of the plurality of users.

In accordance with an embodiment of the present invention, the processor may be further configured to maintain a database of one or more of: the historical and real time decision areas, toll road geometry of the road network, toll locations on the road network, the plurality of first traffic inputs, the second plurality of toll inputs, and the third plurality of user associated inputs, the database may be dynamically updated at a predefined time period.

In accordance with an embodiment of the present invention, the transceiver may be further configured to receive historical incentives offered at the one or more decision areas, and the processor may be further configured to determine the probability of the one or more users taking the at least toll road based on the historical incentives offered at the one or more decision areas.

In accordance with an embodiment of the present invention, the calculation of the incentives may be further based on incentive inputs received from one or more tolling agencies, and current and historical revenues of the respective tolling agency.

In accordance with an embodiment of the present invention, the platform may be further configured to determine an event of the one or more users selecting the at least one toll road based on the transmitted incentives; transmit information associated with the event to the respective tolling agency; verify the event with the respective tolling agency; and perform a payment of toll prices including incentives to the respective tolling agency from the one or more accounts associated with the one or more users, based on the verification of the event.

In accordance with an embodiment of the present invention, the transceiver may be further configured to transmit information associated with the incentives selected by the one or more users, to the respective tolling agency based on the determination of the event. The transceiver may be further configured to transmit information associated with the incentives offered to the one or more users and the calculated probability of the one or more users taking the at least one toll road to the respective tolling agency.

The present invention is further directed towards a method for providing incentives on toll prices to one or more users of a plurality of users. The method may include receiving a first plurality of traffic inputs that comprises one or more of: historical traffic information of a road network, real time traffic information of the road network, information associated with real time events, and throughput of one or more toll roads on the road network. The method may further include receiving a second plurality of toll inputs that comprises one or more of: real time and historical toll prices for one or more toll roads on the road network, historical incentives on the toll prices offered at the one or more toll roads to the plurality of users. The method may further include receiving a third plurality of user inputs that comprises geo-locations of the plurality of users and one or more of: historical travel and driving patterns of the plurality of users on the road network, information on at least one of historical toll and incentives accepted by the plurality of users, user demographics, decision history of the plurality of users taking the one or more toll roads with or without incentives on toll prices, and an information of socio-economic status of the plurality of users. The method may further include identifying one or more decision areas in real time on the road network based on the first plurality of traffic inputs. The decision areas are regions on the road network from where the plurality of users can enter at least one toll road of the one or more toll roads. The method may further include determining one or more users, of the plurality of users, approaching the one or more decision areas, based on the geo-locations of the plurality of users. Based on the first plurality of traffic inputs, the second plurality of toll inputs, and the third plurality of user associated inputs, the method may include determining a probability of the one or more users taking the at least one toll road. The method may further include calculating incentives on the toll prices to be offered to the one or more users to modify the probability of the one or more users taking the at least one toll road. The incentives may be calculated based on the first plurality of traffic inputs, the second plurality of the toll inputs, and the third plurality of user associated inputs. The method may further include transmitting the calculated incentive to the one or more users when the one or more users are at the respective one or more decision areas.

In accordance with an embodiment of the present invention, the incentives may include at least one of increasing the toll prices, decreasing the toll prices, providing round trip discounts, and providing non-monetary benefits.

In accordance with an embodiment of the present invention, identifying the one or more decision areas may include determining traffic source and traffic sink based on the first plurality of traffic inputs; determining a plurality of entrance points, exit points, and toll road locations from where traffic from the traffic source and traffic sink meet the one or more toll roads; determining congestion levels at the plurality of entrance points, exit points and toll road locations based on the first plurality of traffic inputs; and selecting one or more entrance points, exit points and toll road locations which fulfills a predetermined criteria, as the one or more decision areas.

In accordance with an embodiment of the present invention, the method further includes dynamically updating the one or more decision areas based on the first plurality of traffic inputs and driving patterns of the plurality of users.

In accordance with an embodiment of the present invention, the method further includes maintaining a database of one or more of: the historical and real time decision areas, toll road geometry of the road network, toll locations on the road network, the plurality of first traffic inputs, the second plurality of toll inputs, and the third plurality of user associated inputs, the database may be dynamically updated at a predefined time period.

In accordance with an embodiment of the present invention, the method further includes receiving historical incentives offered at the one or more decision areas, and determining the probability of the one or more users taking the at least one toll road based on the historical incentives offered at the one or more decision areas.

In accordance with an embodiment of the present invention, the calculation of the incentives may be further based on incentive inputs received from one or more tolling agencies, and current and historical revenues of the respective tolling agency.

In accordance with an embodiment of the present invention, the method further includes determining an event of the one or more users selecting the at least one toll road based on the transmitted incentives; transmitting information associated with the event to the respective tolling agency; verifying the event with the respective tolling agency; and performing a payment of toll prices including incentives to the respective tolling agency from the one or more accounts associated with the one or more users, based on the verification of the event.

In accordance with an embodiment of the present invention, the method further includes transmitting information associated with the incentives selected by the one or more users, to the respective tolling agency based on the determination of the event.

In accordance with an embodiment of the present invention, the method further includes transmitting information associated with the incentives offered to the one or more users and the calculated probability of the one or more users taking the at least one toll road to the respective tolling agency.

### BRIEF DESCRIPTION OF THE DRAWINGS

FIG. 1 illustrates an environment where the present invention may be implemented, in accordance with an embodiment of the present invention.

FIG. 2 illustrates a system for providing customized toll pricing to a user, in accordance with an embodiment of the present invention.

FIG. 3 illustrates a method for identifying one or more decision areas, in accordance with an embodiment of the present invention.

FIG. 4 illustrates a method for making payment to tolling agency, in accordance with an embodiment of the present invention.

FIG. 5 illustrates a method for calculating incentive on toll pricing and transmitting it to a user, in accordance with an embodiment of the present invention.

FIG. 6 illustrates an overall method performed by different entities to calculate and process payment to the tolling agency, in accordance with an embodiment of the present invention.

### DETAILED DESCRIPTION

Hereinafter, the preferred embodiments of the present disclosure will be described in conjunction with the accompanying drawings. It should be understood that the preferred embodiments described herein are only used to illustrate and explain the present disclosure and are not intended to limit the present disclosure.

The following description includes the preferred best mode of one embodiment of the present invention. It will be clear from this description of the invention that the invention is not limited to these illustrated embodiments but that the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of,” the like.

As used herein, the singular forms “a”, “an”, and “the” designate both the singular and the plural, unless expressly stated to designate the singular only.

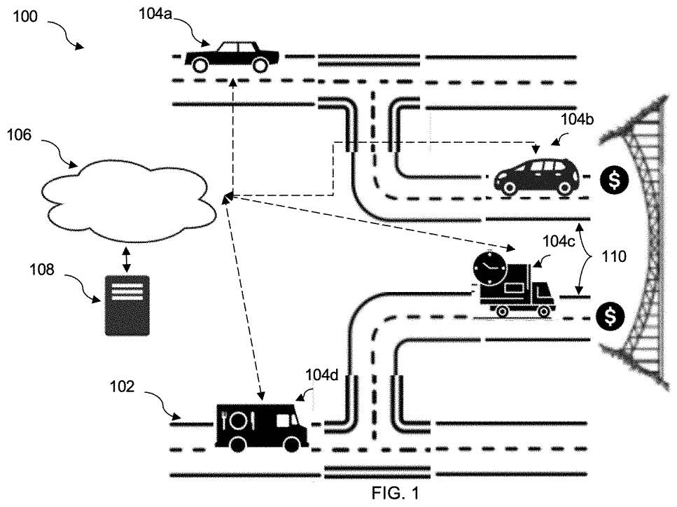

FIG. 1 illustrates an environment 100 where the present invention may be implemented, in accordance with an embodiment of the present invention. The environment 100 may include a road network 102 on which one or more vehicles 104a, 104b, 104c, and 104d (collectively referred to as vehicle 104) may ply. The vehicle 104 may be, for example, a large cargo vehicle, truck, car (shown as vehicles 104a and 104b, bike, pickup truck, emergency vehicle (shown as vehicle 104c), food delivery truck (shown as vehicle 104d) etc.

The environment 100 may further include a network 106 that may be connected to a platform or server 108 (hereinafter, the platform 108 is referred to as server 108). The network 106 may be the internet, intranet, a local area network (LAN), a wide area network (WAN), wireless LAN (WLAN), wireless fidelity (Wi-Fi), and similar networks.

In accordance with an embodiment of the present invention, the vehicle 104 may be connected to the server 108 via the network 106 to receive toll pricing of one or more toll roads 110 on the road network 102. In accordance with another embodiment of the present invention, the user (not shown in FIG. 1) of the vehicle 104 may also make the payment of the toll for using the one or more toll roads 110 to the server 108. In particular, the vehicle 104 may have a transponder or a user device installed on it that accesses a toll payment application that may be hosted on the server 108 to receive the toll pricing and/or to make the payment for using the one or more toll roads 110. A person ordinarily skilled in the art will know that a user device installed on the vehicle 104 may be an On-Board Unit (OBU), a Toll Tag, or a similar device. In accordance with yet another embodiment of the present invention, said user device may not be installed on the vehicle 104, but may be a handheld electronic communication device that is used by the user of the vehicle 104. For example, said user device may be a communication device such as a mobile phone, a smart phone, a mobile node, a smart watch, a GPS tracking device, a personal digital assistant (PDA), a tablet computer, a laptop computer, or the like with communication capabilities, which is associated with the user through which the user accesses the toll payment application hosted on the server 108.

The server 108 may be dedicated to host and run said toll payment application, or may host and run a plurality of different applications. Hereinafter, for the sake of the description of the present invention, it is considered that the server 108 will perform all the operations of said toll payment application. Further, the server 108 may be assumed to be run and managed by one or more tolling agencies, responsible for collecting tolls from users who use the one or more toll roads 110.

In accordance with an embodiment of the present invention, the pricing of the one or more toll roads 110 may be dynamic and customizable for different users, and may be calculated automatically based on a plurality of parameters or inputs. The plurality of inputs may be received from one or more separate servers or databases (not shown in FIG. 1), which collect the plurality of inputs in real time. Alternatively, the plurality of inputs may be fetched from memory of the server 108. The plurality of inputs may include, for example, traffic information such as historical traffic information on the road network 102, real time traffic information on the road network 102, information associated with real time events (concerts, road shows, etc.) to be conducted in the vicinity of the road network 102, and throughput/capacity of the one or more toll roads 110. For instance, the toll price may be increased when the traffic on the one or more toll roads 110 is high and nearing its capacity, and the toll price may be reduced when the traffic is low.

The plurality of inputs may further include toll information such as real time and historical toll prices for the one or more toll roads 110 on the road network 102, historical incentives on the toll prices offered at the one or more toll roads 110 to a plurality of users. For example, special toll discount pricing offered at different times of the year on the one or more toll roads 110, special surge pricing offered on the one or more toll roads 110 in the past (such as during accidents, calamities, congestions), and the like.

Furthermore, the plurality of inputs may include user associated information such as historical travel and driving patterns of the plurality of users on the road network 102, information on at least one of: historical toll and incentives accepted by the plurality of users, user demographics, decision history of the plurality of users taking one or more toll roads 110 with or without incentives on toll prices, and an information regarding socio-economic status of the plurality of users. Additional information such as historical credit card spend information, home and/or office addresses of the plurality of users, details of the vehicles used by the plurality of users, etc. may also be a part of the user associated inputs.

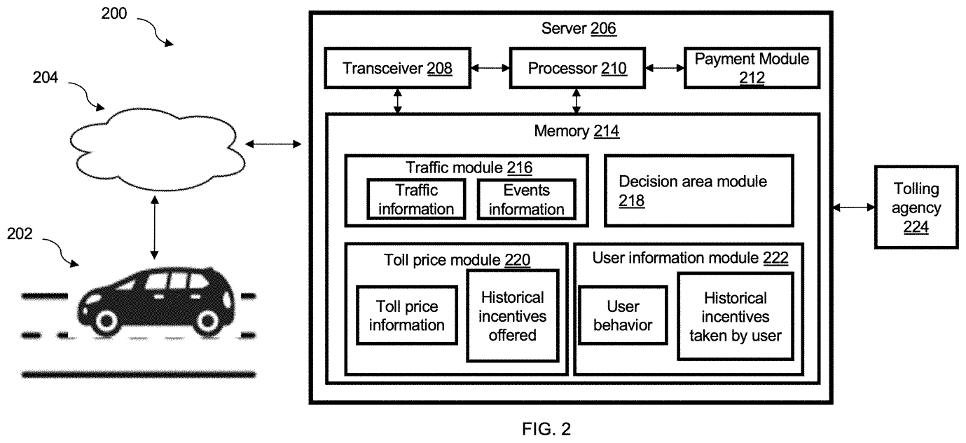

The details of the plurality of inputs, as mentioned above, may be understood in conjunction with the description of FIG. 2.

After the server 108 calculates the toll prices for the one or more toll roads 110 for one or more users of the plurality of users, the real time toll prices may be shown to the one or more users, when they are approaching the one or more toll roads 110, or when they are present at specific location(s) on the road network 102. The specific location(s) may be the entry points on the road network 102 through which the one or more users can enter the one or more toll roads. Further, in accordance with an embodiment of the present invention, the real time toll prices are shown to the one or more users on their user device(s) (not shown in FIG. 1).

The details of the specific location(s) through which the one or more users can enter the toll road, as mentioned above, may be understood in conjunction with the description of FIG. 2.

Once the toll prices are shown to a user in real time, the user may decide to take a toll road of the one or more toll roads 110, or make preference to take non-tolled road segments. When the user decides to take the toll road, which may be determined using geo-location of the user, the server 108 may transmit the event information (i.e. whether the user has passed the toll road or not) to the tolling agency that manages the toll collection of the toll road. The tolling agency may provide confirmation on the event information to the server 108. The confirmation may be provided by the tolling agency, for example, by capturing the license plate of the vehicle 104 through cameras/sensors installed on the toll road, by reading the transponder information from the transponder installed on the vehicle 104 of the user, or similar means. After receiving the confirmation from the tolling agency, the server 108 may perform the payment of the toll to the tolling agency from an account associated with the user. As example, the user may have already shared his account details with the server 108 and may have authorized the server 108 to deduct the toll from his account, whenever he uses a toll road. This way, the server 108 pays the toll to the tolling agency on the user's behalf, and hence the chances of missing toll payment is greatly reduced. Also, user inconvenience is considerably reduced, as there is a single point of payment (server 108) for the user, even if the user uses different toll roads manages by different tolling agencies.

Although it is mentioned above that the payment is made by the server 108 after the tolling agency confirms that the user has used the toll road, in accordance with another embodiment of the present invention, the server 108 may make the payment of the toll to the tolling agency, even if no confirmation is received from the tolling agency. This embodiment is useful in scenarios where the tolling agency fails to detect that the user has passed through the toll road, but is detected by the server 108 by tracking the user using geo-location of the vehicle 104 of the user. This way, the server 108 acts as a “backup” to the tolling agency for detecting users that use the toll road and ensures that no toll payment is missed.

FIG. 2 illustrates a system 200 for providing toll pricing to a user, in accordance with an embodiment of the present invention. The system 200 may include a vehicle 202 that may ply on the road network 102, a network 204 and a server 206. The vehicle 202 may be connected to the server 206 via the network 204. For example, a user (not shown in FIG. 2) of the vehicle 202 may use a user device (not shown in FIG. 2) to access the server 206 via the network 204. The user device may be installed on the vehicle 202, or may be a handheld device used by the user, as mentioned in FIG. 1.

In accordance with an embodiment of the present invention, the server 206 may include, but not limited to, a transceiver 208, a processor 210, a payment module 212, and a memory 214. The memory 214 may be an integrated circuit (IC) memory chip containing any form of random-access memory (RAM) or read-only memory (ROM), a floppy disk, a compact disk read-only memory (CD-ROM), a hard disk drive, a digital video disc (DVD), a flash memory card, external subscriber identity module (SIM) card or any other medium for storing non-transitory digital information. In accordance with an embodiment of the present invention, the memory 214 may include one or more modules such as a traffic module 216, a decision area module 218, a toll price module 220, and a user information module 222.

In accordance with an embodiment of the present invention, the transceiver 208 may be configured to receive a first plurality of traffic inputs associated with the road network 102. The first plurality of traffic inputs may be received from one or more separate servers or databases (not shown in FIG. 2), that is dedicated to receive traffic related information on a real-time basis and transmit the information to the server 206. In accordance with another embodiment of the present invention, the first plurality of traffic inputs may be fetched from the memory 214 of the server 206.

The first plurality of traffic inputs, as mentioned above, may include one or more of: historical traffic information of the road network 102, real time traffic information on the road network 102, information associated with real-time events planned in the vicinity of the road network 102, throughput of one or more toll roads on the road network 102. The historical traffic information may include information associated with traffic conditions on the road network 102 at different times of the day and different days. For example, the information may include the number of vehicles on the road network 102 at different times of weekdays and weekends, information about usual times of the day/week/year when there is congestion on one or more roads on the road network 102, information on times when fleet or cargo vehicles usually ply on the road network 102, etc. The real time traffic information may include information associated with accidents on the road network 102, breakdown on the road network 102, real time traffic and congestion information on various locations/roads on the road network 102, and the like. Further, the information associated with the events may include information and timings associated with soccer matches, tournaments, concerts or shows, flights, trains, transit times, and the like, near the road network 102.

In accordance with further embodiment of the present invention, the transceiver 208 may be configured to receive/fetch a second plurality of toll inputs from one or more separate servers, or databases, or from the memory 214 of the server 206. The second plurality of toll inputs may include one or more of real time and historical toll prices for the one or more toll roads 110 on the road network 102, historical incentives on the toll prices offered at the one or more toll roads 110 to a plurality of users (special discount or surge toll pricing offered on the one or more toll roads on special occasions of the year like Christmas, Thanksgiving, vacation months, etc.), and the like. For instance, the transceiver 208 may receive information on the previous incentive (e.g. discount) offered to a user “A” on the toll pricing at a toll road “B”, or previous all the incentives offered to the user “A” at the toll road “B” during a predetermined time period (such as 1 month or 3 months or 1 year). In addition, the transceiver 208 may receive information associated with different circumstances at which the historical incentives were offered. For example, the transceiver 208 may receive information that the user usually accepts a 5% surge on the toll pricing when he is traveling from office to home in the evening.

In accordance with further embodiment of the present invention, the transceiver 208 may be configured to receive/fetch a third plurality of user associated inputs from a one or more separate servers or databases, or from the memory 214 associated with the server 206. The third plurality of user associated inputs may include real time geo-locations of the plurality of users, which may be received by tracking one or more user devices (not shown in FIG. 2) associated with the user or installed on the vehicles used by the plurality of users. The third plurality of user associated inputs may further include one or more of historical travel and driving patterns of the plurality of users on the road network 102, information on at least one of historical toll and incentives accepted by the plurality of users, user demographics, decision history of the plurality of users taking one or more toll roads 110 with or without incentives on toll prices, and an information associated with socio-economic status of the plurality of users. Additional information, such as the plurality of users' home and/or office locations, credit card spend information, details of vehicles owned by the plurality of users, etc. may also be a part of the third plurality of user associated inputs.

In accordance with an embodiment of the present invention, the transceiver 208 may receive the information associated with different circumstances and times when each user, of the plurality of users, prefers to take the one or more toll roads 110 or the non-tolled road segments. For example, the user may prefer to travel via the one or more toll roads 110 during weekdays, and may prefer to take non-tolled road segments during weekends. In addition, the transceiver 208 may receive the past incentives on toll prices accepted or declined by the user. For instance, the transceiver 208 may receive the information that the user previously accepted to travel through the one or more toll roads 110 when the toll prices were below “A” dollars or accepted to travel via the one or more toll roads 110 at a high price “B” when the purpose of the travel of the user was to catch a flight. Similarly, the transceiver 208 may receive information indicating that the user usually declines to use the one or more toll roads 110 on a weekend or when going to a tourist spot, unless more than 15% discounts are offered to him on the base toll prices. Alternatively, the information may indicate that the user may be willing to pay an even 25% surge on toll prices when his destination location is the airport, or when he is going to his office on weekdays and/or is getting late reaching the office and is past his usual time to reach the office.

Further, as briefly mentioned above, the transceiver 208 may receive credit card spend information of the user during a predetermined time period (e.g. last 3 months, 6 months or 1 year), his income level, total toll amount paid in a predetermined time period, outstanding toll amount, frequency of using the toll road and frequency of the payment of the toll prices, information associated with toll roads used in the past and respective tolls paid (including information of the locations where the toll road and non-tolled road segments were used), and the like.

In accordance with another embodiment of the present invention, the transceiver may receive/fetch additional real-time and historical road information from one or more separate servers or databases, or from memory 214 of the server 206. The additional road information indicates one or more roads on the road network 102 that might be closed for a certain period of time due to maintenance/construction, or due to bad weather. Additional road information may also include information related to historical average speeds of vehicles that ply on the one or more roads during different times of day/week/year, popular destination locations on the one or more roads where the users usually stop during their travel, etc.

In accordance with an embodiment of the present invention, the transceiver 208 may be further configured to receive account/payment information and vehicle license plate information associated with the plurality of users. Such information may be received directly from the user, or from a one or more separate servers or databases that includes the above-mentioned information. In addition, the transceiver may be configured to receive details of one or more tolling agencies and their associated toll road locations. Examples of such details may be names of tolling agencies, payment modes, one or more toll roads managed by them, etc. Such information may be directly received from the one or more tolling agencies or from a one or more separate servers or databases that includes the above-mentioned information.

The transceiver 208 may be configured to receive all the above-mentioned inputs periodically. Also, the above-mentioned inputs may be received simultaneously or in any sequence. As and when the above-mentioned inputs are received by the transceiver 208, they may be stored in the memory 214 of the server 206, and may be processed by the processor 210. For instance, the first plurality of traffic inputs may be stored in the traffic module 216, the second plurality of toll inputs may be stored in the toll price module 220, the third plurality of user associated inputs may be stored in the user information module 222, and the addition road information may be stored in the traffic module 216 or a separate module (not shown in FIG. 2). The processor 210 may be configured to access and process the one or more inputs received by the transceiver 208.

The processor 210 may include one or more microprocessors, microcontrollers, digital signal processors (DSPs), state machines, logic circuitry, or any other device or devices that process information based on operational or programming instructions. Such operational or programming instructions may be stored in the memory 214. One of ordinary skill in the art will recognize that when the processor 210 has one or more of its functions performed by a state machine or logic circuitry, the memory 214 containing the corresponding operational instructions can be embedded within the state machine or logic circuitry.

In accordance with an embodiment of the present invention, the processor 210 may be configured to command the traffic module 216 to fetch the first plurality of traffic inputs from the one or more separate servers. Once this command is sent to the traffic module 216, the traffic module 216 requests the transceiver 208 to receive the first plurality of traffic inputs from the separate server (and the transceiver 208 then receives the inputs from the separate server, as mentioned earlier). Similarly, the processor 210 may command the toll price module 220 and the user information module 222 to respectively fetch the second plurality of toll inputs and third plurality of user inputs, using the transceiver 208.

Once the inputs are received (specifically the first plurality of traffic inputs), the processor 210 may command the decision area module 218 to identify one or more decision areas (or specific “location points”) on the road network 102 based on the first plurality of traffic inputs. Specifically, the one or more decision areas may be identified based on the real time traffic information on the road network 102. In accordance with an embodiment of the present invention, the one or more decision areas are regions on the road network 102 from where the plurality of users can enter at least one toll road of the one or more toll roads 110. In other words, the decision areas are areas on the road network 102 from where a user may either select to take the toll road or bypass it (i.e., not use the toll road). An example of a decision area is shown in FIG. 1, specifically the intersection of the roads at which the vehicle 104d is heading. In accordance with an embodiment of the present invention, the decision areas on the road network are not merely all the intersections of roads on the road network 102, but may be a subset of the intersections from where probability of the traffic entering the toll road is high. For example, there could be three intersections (intersection 1, 2 and 3; not shown in FIG. 1 or 2) on the road network 102 from where the users can enter a toll road, however based on the historical traffic information, it may be determined that majority of the traffic enters the toll road from intersection 3. In this case, intersection 3 may be identified as a decision area by the processor 210, and not intersections 1 or 2. Furthermore, in accordance with an embodiment of the present invention, the decision areas on the road network 102 are dynamic, and may change based on real-time traffic inputs. Continuing the same example as used above, if the real-time traffic inputs indicate that majority of the traffic is entering the toll road from intersection 1 and not from intersection 3 (for various reasons, such as vehicle breakdown, low traffic near intersection 3, etc.), then intersection 1 is identified as the decision area for the toll road.

The identification of such decision areas on the road network 102 are quite beneficial as the traffic on the one or more toll roads 110 may be controlled by dynamically changing the toll prices and displaying them to the user when he is passing the one or more identified decision areas. This may alter the user's probability of taking the toll road, and hence would help in regulating traffic on the one or more toll roads 110 and optimizing revenue for the tolling agencies that manage the toll collection of the one or more toll roads 110.

In accordance with an exemplary embodiment of the present invention, the one or more decision areas may be identified as follows. Firstly, the processor 210 may determine one or more traffic sources and one or more traffic sinks on the road network 102 based on the first plurality of traffic inputs. For instance, the traffic source may be a residential location, and the traffic sink may be an office area in the morning. Similarly, the traffic source may be the office area, and the traffic sink may be the residential location in the evening. In other words, the traffic source and the traffic sink information may be dynamic and may be updated/received periodically or in real-time.

Once the traffic source and traffic sink are identified, a plurality of entrance points, exit points, and toll road locations from where traffic from the traffic source and traffic sink meet the one or more toll roads 110 are identified. For instance, the processor 210 may determine all the points (entrance, exit points) on the one or more toll roads that connect the residential area “A” and the office area “B”. After the determination of the plurality of entrance points, exit points, and toll road locations, the processor 210 may be configured to determine real time congestion levels at the plurality of entrance points, exit points and the one or more toll roads locations using the first plurality of traffic inputs. In accordance with an embodiment of the present invention, the congestion level may be obtained from one or more separate servers or directly from sensors/cameras installed on the road network 102. Thereafter, the processor 210 may select one or more entrance points, exit points and toll road locations, from the plurality of entrance points, exit points and the toll roads locations, as the one or more decision areas that fulfill a predetermined criteria. For instance, the processor 210 may identify those areas as decision areas where the deviation (positive or negative) of the congestion level and/or real time revenue generation (from the toll roads) exceeds a predetermined threshold. As an example, the processor 210 may seta regular or “acceptable” traffic volume on a toll road. Here, regular or acceptable traffic volume may mean that traffic volume on the toll road at which there is no congestion (and hence no inconvenience to commuters) and the tolling agencies meet their revenue targets. Now, whenever the traffic on the toll road deviates beyond a predetermined threshold (e.g. +/−25%) from the regular or acceptable traffic volume, the entry points to the toll road may be determined as decision areas by the processor 210. A person ordinarily skilled in the art may appreciate that the identified one or more decision areas are thus dynamic in nature, and vary based on real time traffic information.

In accordance with an exemplary embodiment of the present invention, the processor 210 may select the one or more entrance points, exit points and toll road locations by making a distance vs. time graph for the plurality of entrance points, exit points and toll road locations. Thereafter, the processor 210 may be configured to identify top X % (e.g. 10% or 20%) of the plurality of entrance points, exit points and toll road locations as the one or more decision areas. In other words, the processor 210 may be configured to select top A % of the highly congested points/locations as decision areas, in accordance with an embodiment of the present invention. The number of decision areas may be predetermined or dynamically selected by the processor 210 based on the first plurality of traffic inputs.

An ordinary person skilled in the art may appreciate that the identification of the one or more decision areas may be dynamic in nature, and the processor 210 may be configured to dynamically update the one or more dynamic areas. In accordance with an embodiment of the present invention, the one or more decision areas may be dynamically updated based on the first plurality of the traffic inputs and/or based on real time user driving pattern. Once the one or more decision areas are identified, the information associated with the one or more dynamic areas may be stored in the memory 214 of the server 206 and is updated periodically. In accordance with further embodiment of the present invention, the one or more decision areas may be identified in a static manner, such as based on the population density of a given area near the road network 102, or based on toll road geometry or toll location on the road network 102, or based on historical travel pattern on the road network 102, which may also be stored in the memory 214 of the server 206 and are updated periodically.

In accordance with further embodiment of the present invention, the processor 210 may be configured to determine one or more users, of the plurality of users, approaching the one or more identified decision areas, based on the tracked geo-locations of the plurality of users (i.e. based on the tracked location of the plurality of users/their vehicles, which is part of the third plurality of inputs received by the server 206).

When the processor 210 determines the one or more users approaching the one or more identified decision areas, the processor 210 may determine/assign a probability of the one or more users taking the toll road of the one or more toll roads 110, based on the first plurality of toll inputs, the second plurality of toll inputs, and the third plurality of user associated inputs. The probability may be assigned using artificial intelligence and machine-learning algorithms. In accordance with an exemplary embodiment of the present invention, the processor 210 may receive real time toll price of a toll road (as a “base” toll price), which may be fixed for specific times of the day/week for the one or more toll roads 110, or may be dynamic such that the base toll prices fluctuate based on the traffic condition/congestion on the toll roads or other parameters (such as accidents on the toll roads, special events organized near the road network 102, etc.). After receiving the “base” toll price, the processor 210 may be configured to compare the “base” toll price with historical toll prices (with or without incentives) offered at the respective toll road (or other toll roads), and the historical toll prices (with or without incentives) accepted or declined by the user for the respective toll road (or other toll roads) to determine whether a user will accept a toll road or non-tolled road segment. For example, if the current base toll price of a toll road is “A” dollars, and the historical trend of the toll prices offered to a user indicates that the user not even accepts toll prices which are 10% lesser than “A”, then the processor 210 may assign a probability of the user taking the toll road close to 0%. In another scenario, based on the historical data, the processor 210 may determine that whenever the user is going to the airport, he is ready to pay a surge of 20% over “A” dollars, then the processor 210 may assign a probability of close to 100% for the user taking the toll road, if the purpose of his travel is to catch a flight (i.e. destination location is the airport).

Based on the determination of the probability of the user taking the toll road or non-tolled road segment, the processor 210 may be further configured to calculate incentive on the “base” toll prices, in real-time, to be offered to the one or more users when the one or more users are in the one or more decision areas. The incentives may be provided to the one or more users to alter their probability of taking the toll road. The incentives may include at least one of increasing the toll prices, decreasing the toll prices, providing round trip discounts, and providing non-monetary benefits. The incentives may be calculated based on the first plurality of traffic inputs, the second plurality of the toll inputs, the third plurality of user inputs, and the throughput of the at least one toll road.

For instance, when the traffic on a toll road is high (as identified from the first plurality of traffic inputs), and the probability of the user taking the toll road, based on historical travel pattern (as identified from the third plurality of user associated inputs) and the current base toll price (as identified from the second plurality of toll inputs), is greater than a predetermined threshold, the processor 210 may increase the toll prices (i.e. add “surge” to the base toll price) so that the user avoids the toll road. The actual toll price (to be charged from the user) may be calculated or decided based on the historical incentives offered to the user and the historical incentives accepted or declined by the user and/or other user associated inputs (such as purpose of travel, socio-economic status of the user etc.) at the one or more decision areas. In other words, the processor 210 may calculate a toll price which may not be accepted by the user, thus diverting him to take the non-tolled road segment. On the other hand, if the traffic on the toll road is low, and the probability of the user taking the toll road is also low (less than a predetermined threshold), the processor 210 may decrease the toll price or provide discount to the user so that the user takes the toll road (i.e. reduce the toll price to change the probability of the user taking the toll road from low to high). In another scenario, when the traffic on the toll road is moderate, the processor 210 may be configured to keep the “base” toll price unchanged.

In accordance with further embodiments of the present invention, the incentives may be calculated based on one or more of “incentive inputs” received from one or more tolling agencies that manage the toll roads on the road network 102, and current and historical revenues of the one or more tolling agencies. Specifically, the incentive inputs may include revenue targets of the one or more tolling agencies, maximum and minimum limit of the toll price for the respective toll roads, target travel time and target speed on a toll road, maintenance cost, toll price charged by other tolling agencies, and the like. For instance, if the revenue generated during the first 15 days of a month is just 30% of the target revenue, the tolling agency may want to increase the toll prices for all future trips in order to achieve the target revenue. In this case, the one or more tolling agencies may indicate to the server 206 to not provide any discounts on toll prices to the users using the toll roads, and may also indicate an increase in the “base” toll prices for the rest of the month.

In accordance with another embodiment of the present invention, the “incentive inputs” received from one or more tolling agencies, the current and historical revenues of the one or more tolling agencies, and the second plurality of toll inputs may be used to identify the one or more decision areas. For instance, the processor 210 may identify one or more toll roads that are under-utilized and unable to generate the target toll revenue. In this case, the processor 210 may then select/identify decision areas which are in the vicinity of the identified one or more toll roads. Based on the identification of such one or more decision areas, the processor 210 may be configured to provide incentives (such as discounts) in order to maximize the revenue generation from the under-utilized toll roads.

In accordance with further embodiment of the present invention, when the incentives (positive or negative) are calculated, the transceiver 208 may be configured to transmit the calculated incentive to the one or more users at the one or more decision areas. In other words, the transceiver 208 may be configured to display the calculated incentive when the user is in a decision area or when he is entering the decision area so that he may change his decision of taking the toll road or the non-tolled road segment. For instance, the calculated price/incentive may be displayed to the user when he is 3-5 miles away from the toll road. In accordance with an embodiment of the present invention, the processor 210 may be further configured to transmit the calculated incentives, calculated and altered probability of the user taking the toll road to respective tolling agency 224.

Once the calculated prices are transmitted to the one or more users, the processor 210 may be further configured to determine an event of the one or more users selecting the toll road or passing through the toll road. The determination may be made by using geo-location of the one or more users. The information associated with the event may be transmitted to the tolling agency 224 to confirm the passage of the one or more users from the toll road. Once the event associated information is transmitted to the tolling agency 224, the tolling agency 224 may confirm the event. The confirmation may be provided by the tolling agency, for example, by capturing the license plate of the vehicle 104 through cameras/sensors installed on the toll road, by reading the transponder information from the transponder installed on the vehicle 104 of the user, or similar means. Based on the response/confirmation from the tolling agency 224, the processor 210 may be configured to “verify” the event. The verification here means that the server 206, through its payment module 212, performs the payment of the toll to the tolling agency 224 on behalf of the one or more users using the toll road. The payment may be made by the payment module 212 on behalf of the user to the tolling agency 224 from one or more accounts associated with the user.

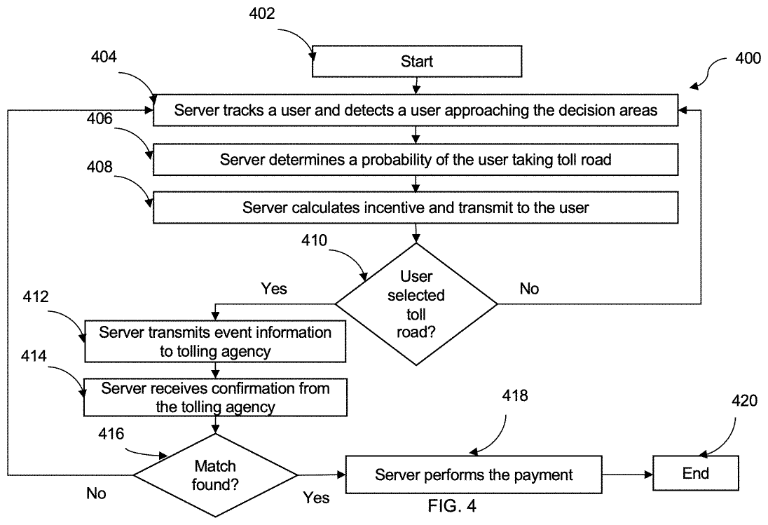

In accordance with further embodiments of the present invention, the transceiver 208 may be further configured to send or transmit information associated with the incentives selected by the one or more users, to the tolling agency 224 based on the determination of the event. In addition, the transceiver 208 may be further configured to transmit information associated with the incentives offered to the one or more users and the calculated probability of the one or more users taking the at least one toll road to the tolling agency 224. The details of the process of making the payment may be understood in conjunction with the description of FIG. 4.

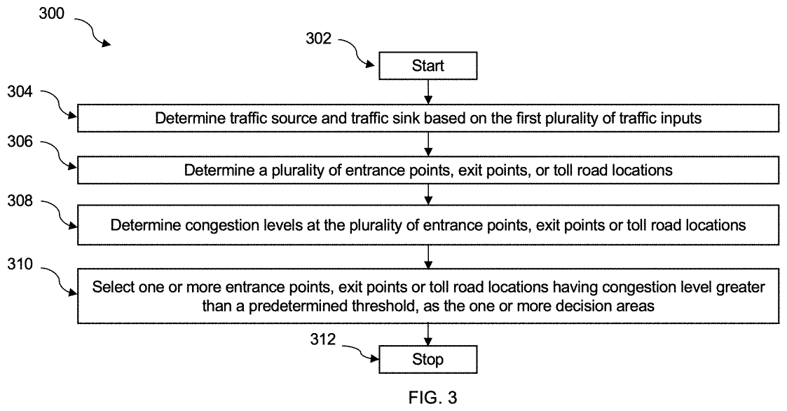

FIG. 3 illustrates a method 300 performed by the server 206 for identifying one or more decision areas, in accordance with an exemplary embodiment of the present invention. The method 300 starts at 302. At step 304, the method 300 includes determining one or more traffic sources and one or more traffic sinks based on the first plurality of traffic inputs (i.e. based on historical traffic information of the road network 102, real time traffic information of the road network 102, and information associated with real time events). The details of the traffic sources and traffic sinks are already provided above in FIG. 2. The determination of the one or more traffic sources and the one or more traffic sinks may be based on the first plurality of traffic inputs. Specifically, the determination may include receiving/fetching the traffic information from one or more separate servers or from the memory 214 of the server 206, and then identifying the traffic source and traffic sinks dynamically at different times of a day or at a predetermined frequency by the server 206. In accordance with another embodiment of the present invention, the traffic sources and traffic sinks may be static for a predetermined period of time (e.g. they are not changed in real-time and may be updated after a fixed frequency of time/days).

Once the one or more traffic sources and the one or more traffic sinks are identified, the method 300 includes determining a plurality of entrance points, exit points, and toll road locations from where traffic from the one or more traffic sources and one or more traffic sinks meet the one or more toll roads 110, at step 306. The determination of the plurality of entrance points, exit points, and toll road locations includes receiving/fetching, by the server 206, the location of various toll road locations, toll road geometry from a separate server or from the memory 214 of the server 206, and then identifying the plurality of entrance points, exit points, and toll road locations.

Once the plurality of entrance points, exit points, and toll road locations are determined, the method 300 moves to step 308. At this step, the method 300 includes determining congestion levels at the plurality of entrance points, exit points, and toll road locations. The congestion levels (or traffic information) on the road network 102 may be received in real time from a separate server or directly from the cameras/sensors installed on the road network 102. In accordance with another embodiment of the present invention, the server 206 may predict the congestion levels on the plurality of entrance points, exit points and the toll road locations based on the historical traffic information and other traffic inputs (such as the first plurality of traffic inputs as discussed in FIG. 2).

Once the congestion levels are determined at step 308, the method 300 moves to step 310. As this step, the method 300 includes selecting one or more entrance points, exit points or toll road locations, from the plurality of entrance points, exit points and toll roads locations, as the one or more decision areas that fulfill a predetermined criteria. The details of the predetermined criteria may be understood in conjunction with description of FIG. 2. The method ends at step 312.

FIG. 4 illustrates a method 400 performed by the server 206 for calculating incentives/toll prices and for making payment to one or more tolling agencies, in accordance with an embodiment of the present invention. The method 400 starts at 402. At step 404, the server 206 tracks a user (by tracking his geo-location as mentioned earlier in conjunction with FIG. 2), and detects whether the user is approaching the one or more identified decision areas. For instance, the server 206 may track the user device and/or vehicle associated with the user to detect whether the user is approaching the one or more decision areas. In accordance with an embodiment of the present invention, the server 206 may detect that the user is approaching the one or more decision areas by receiving details from various sensors and/or cameras installed on the road network 102, or through GPS.

At step 406, the server 206 may determine the probability of the user taking the one or more toll roads when the user is approaching the one or more decision areas or when the user is at the one or more decision areas. The probability may be determined based on the first plurality of traffic inputs, the second plurality of toll inputs, and the third plurality of user inputs (such as historical driving pattern and other user preferences), as mentioned above in conjunction with FIG. 2. Thereafter, at step 408, the server 206 may calculate incentives on the “base” toll prices to be offered to the one or more users to alter their probability of taking the toll road. The incentives may be customized for each user and may include at least one of increasing the toll prices, decreasing the toll prices, providing round trip discounts, and providing non-monetary benefits. The incentives/toll price may be calculated based on the first plurality of traffic inputs, second plurality of the toll inputs, the third plurality of user inputs, and throughput of the at least one toll road as mentioned above. In accordance with further embodiments of the present invention, the incentives may be calculated based on one or more of incentive inputs received from a tolling agency, and current and historical revenues of the tolling agency, as mentioned above in conjunction with FIG. 2.

Once the incentives/toll prices are calculated, the server 206 may transmit the calculated revised toll price (after factoring in incentives over the base toll price) to the user when the user is at the one or more decision areas or approaching the one or more decision areas. In other words, the server 206 may cause the user to display the incentives/toll price, on the user device, when the user is at the one or more decision areas, so as the user may take the decision for taking the toll road or non-tolled road segments. In accordance with an embodiment of the present invention, the calculated probability, altered probability, and the calculated incentive may be transmitted to the tolling agency 224. Next, at step 410, the server 206 determines whether the user has selected the toll road or the non-tolled road segment, by tracking geo-location of the user. In case the user has selected the non-tolled road segment, the method 400 moves back to step 404, where the server 206 continues to track the user and detect whether the user is approaching the one or more decision areas. Alternatively, if the user selects the toll road, the method 400 moves to step 412.

At step 412, the server 206 transmits event information (i.e. information regarding passage of the user through the toll road) to the respective tolling agency that manages said toll road. In response to receiving the event information, the tolling agency may provide confirmation to the server 206, whether the user has passed the toll road or not. For this confirmation, the tolling agency may use conventional cameras/sensors to capture the movement of vehicles from the toll road (such as by capturing license plate information, or by reading transponders installed on the vehicle of the user).

When the server 206 receives the confirmation associated with the event information from the tolling agency at step 414, the method 400 moves to step 416. At this step, the server 206 compares the captured information (from step 410) and the information received from the tolling agency (from step 414), to determine if these information match against each other or not, at step 416. In a scenario where no match is found (i.e. no event information is captured by the tolling agency), the method 400 moves back to step 404, in which the server 206 continues to track the user and detects whether the user is approaching the next decision area. In this scenario, the server 206 does not make the payment to the tolling agency, and does not charge anything from the user.

In another scenario, where the server 206 determines a match (i.e. event information is captured by the tolling agency) at step 416, the method 400 moves to step 418. At this step, the server 206 performs the step of making the payment to the tolling agency from the account associated with the user. At this step, the server 206 pays the effective toll price (i.e. based on base toll price and the incentives offered and accepted by the user) to the tolling agency. The method ends at step 420.

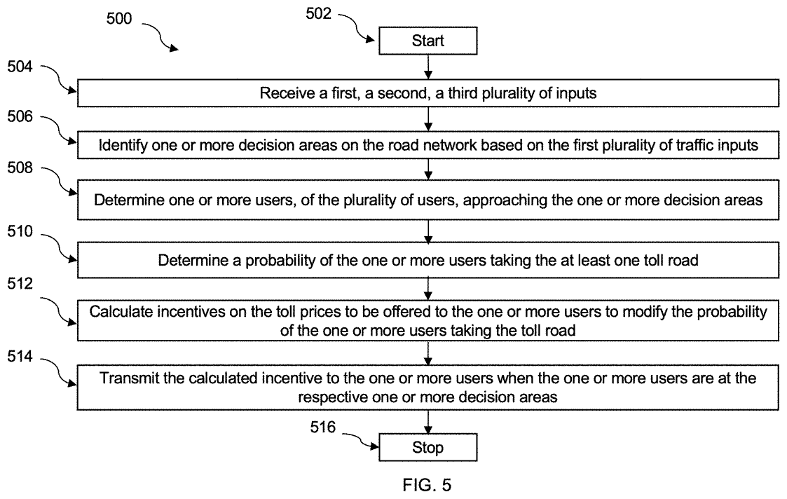

FIG. 5 illustrates a method 500 performed by the server 206 for calculating incentive on toll pricing and transmitting it to a user, in accordance with an embodiment of the present invention. The method starts at step 502. At step 504, the method 500 includes receiving a first plurality of traffic inputs, a second plurality of toll inputs, and a third plurality of user associated inputs. The details of the first plurality of traffic inputs, the second plurality of toll inputs, and the third plurality of user associated inputs are already explained in conjunction with FIG. 2.

Next, at step 506, the server 206 identifies one or more decision areas based on the first plurality of traffic inputs. The details of the identification of the one or more decision areas are already explained above in conjunction with FIGS. 2 and 3. In response to the identification of the one or more decision areas, the server 206 continue to monitor the identified one or more decision areas and keep on updating the decision areas as and when new inputs (first plurality of traffic inputs, second plurality of toll inputs, and third plurality of user associated inputs) are received. At step 508, the server 206 determines one or more users, of the plurality of users, who are approaching the one or more decision areas. This step may be performed by tracking the geo-location of the users and/or by using conventional sensors/cameras installed on the road network 102, as mentioned in conjunction with above FIGS. 2-4.

Based on a determination that the one or more users are approaching the one or more decision areas, the server 206 determines a probability of the one or more users taking the toll road, at step 510. The determination of the probability of the one or more users taking the toll road may be based on the first plurality of traffic inputs, the second plurality of toll inputs and the third plurality of user inputs, as already mentioned above in conjunction with FIGS. 2-4.

At step 512, the server 206 calculates incentives on the toll prices to be offered to the one or more users to alter their probability of taking the toll road. The incentives may be calculated based on a plurality of parameters, which are already described above in conjunction with FIGS. 2-4. The calculated incentives may be transmitted (or displayed) to the one or more users when the one or more users are either approaching the one or more decision areas or when they are at the one or more decision areas, at step 514. The method 500 ends at step 516.

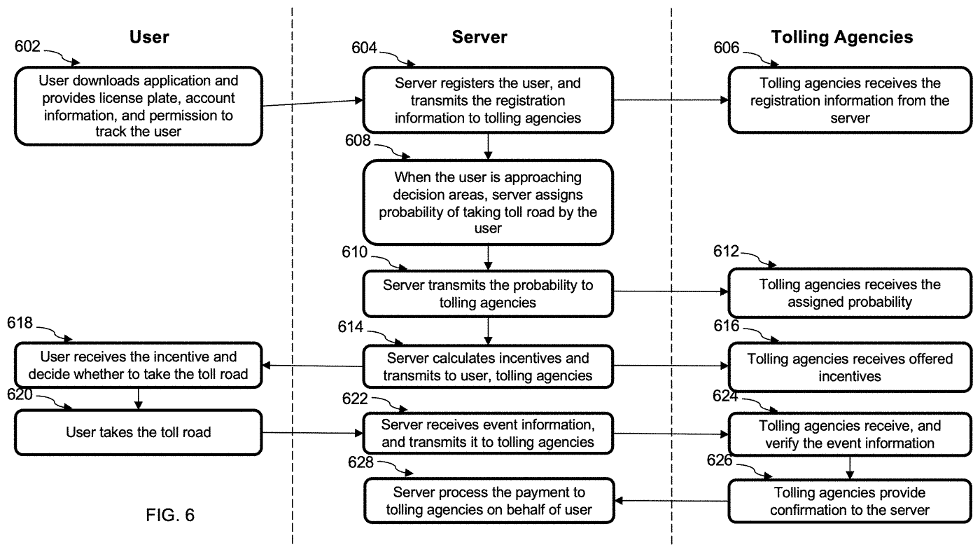

FIG. 6 illustrates an overall method performed by different entities to calculate and process payment to the tolling agency, in accordance with an embodiment of the present invention. As mentioned above in description of FIGS. 1 and 2, a user of the vehicle 202 may access the server 206 to receive the toll pricing and to make the toll payment. Specifically, at step 602, in order to access the server 206, the user may download the toll payment application (hosted on the server 206). Once the application is downloaded, the user provides license plate, account information to the server 206. In addition, the user provides permission to the server 206 to track the user. This step is performed to register the user on the serve 206 (i.e. on the toll payment application). After receiving such details, the server 206 registers the user at step 604, and transmits the registration information to one or more tolling agencies. In particular, the server 206 stores details of the one or more tolling agencies and their respective toll locations. Thereafter, the one or more tolling agencies receive registration information from the server 206 at step 606.

After the user is registered on the server 206, the server 206 continues to track the user. At step 608, when the user is approaching decision areas, the server 206 determines/assigns probability of the user taking the toll road The determination of the probability of the one or more users taking the toll road may be based on the first plurality of traffic inputs, the second plurality of toll inputs and the third plurality of user inputs, as already mentioned above in conjunction with FIGS. 2-5. At step 610, the server 206 transmits the probability to the one or more tolling agencies, which may be received by the one or more tolling agencies at step 612.

At step 614, the server 206 calculates incentives on the toll prices to be offered to the one or more users to alter their probability of taking the toll road. The incentives may be calculated based on a plurality of parameters, which are already described above in conjunction with FIGS. 2-5. Once the incentives are calculated, it may be transmitted to the user and the one or more tolling agencies. The incentives may be received by the one or more tolling agencies at step 616, and may be received by the user at step 618. At step 618, once the user receives the incentives, the user may decide whether to take the toll road. In a scenario, where the user takes a non-tolled road segment, the server 206 continues to track the user. In another scenario, where the user takes the toll road (event), at step 620, the server 206 receives the event information and transmits the event information to the one or more tolling agencies at step 622. In particular, the server 206 may transmit the event information to those tolling agencies who are associated with the toll road used by the user.

At step 624, the respective tolling agencies receive the event information, and verify the event information. The details of the verification may be already explained above in conjunction with FIGS. 2-5. After the verification, the respective tolling agencies provide the confirmation (or result of the verification) to the server 206, at step 626. Thereafter, the server 206 processes the payment of the respective tolling agency on behalf of the user (i.e. through the account associated with the user). The details of the payment are already explained above in conjunction with FIGS. 1-5. Although the details are explained using a single user/vehicle, a person ordinary skilled in the art may appreciate that the present invention may be applicable for a plurality of users/fleet.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments that fall within the scope of the appended claims.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method described herein. Alternatively, some or all functions could be implemented by a state machine that has no stored program instructions, or in one or more application specific integrated circuits (ASICs), in which each function or some combinations of certain of the functions may be implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM, a Programmable Read Only Memory (PROM), an Erasable Programmable Read Only Memory (EPROM), an Electrically Erasable Programmable Read Only Memory (EEPROM) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. The present disclosure may be realized in hardware, or a combination of hardware and software. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

I/we claim:

1. A platform for providing incentives on toll prices to one or more users of a plurality of users, the platform comprising:
a transceiver configured to:
receive a first plurality of traffic inputs that comprises one or more of: historical traffic information of a road network, real time traffic information of the road network, information associated with real time events, and throughput of one or more toll roads on the road network;
receive a second plurality of toll inputs that comprises one or more of: real time and historical toll prices for the one or more toll roads on the road network, historical incentives on the toll prices offered at the one or more toll roads to the plurality of users; and
receive a third plurality of user associated inputs that comprises geo-locations of the plurality of users and one or more of: historical travel and driving patterns of the plurality of users on the road network, information on at least one of historical toll and incentives accepted by the plurality of users, user demographics, decision history of the plurality of users taking the one or more toll roads with or without incentives on toll prices, and an information of socio-economic status of the plurality of users; and
a processor configured to:
identify one or more decision areas in real time on the road network based on the first plurality of traffic inputs, wherein the decision areas are regions on the road network from where the plurality of users can enter at least one toll road of the one or more toll roads;
determine one or more users, of the plurality of users, approaching the one or more decision areas, based on the geo-locations of the plurality of users;
determine a probability of the one or more users taking the at least one toll road, based on the first plurality of traffic inputs, the second plurality of toll inputs, and the third plurality of user associated inputs;
calculate incentives on the toll prices to be offered to the one or more users to modify the probability of the one or more users taking the at least one toll road, wherein the incentives are calculated based on the first plurality of traffic inputs, the second plurality of the toll inputs, and the third plurality of user associated inputs;
wherein the transceiver is further configured to transmit the calculated incentives to the one or more users when the one or more users are at the respective one or more decision areas.

2. The platform of claim 1, wherein the incentives comprise at least one of increasing the toll prices, decreasing the toll prices, providing round trip discounts, and providing non-monetary benefits.

3. The platform of claim 1, wherein the identification of the one or more decision areas comprises:
determine traffic source and traffic sink based on the first plurality of traffic inputs;
determine a plurality of entrance points, exit points, and toll road locations from where traffic from the traffic source and traffic sink meet the one or more toll roads;
determine congestion levels at the plurality of entrance points, exit points and the toll road locations based on the first plurality of traffic inputs; and
select one or more entrance points, exit points and toll road locations which fulfils a predetermined criteria, as the one or more decision areas.

4. The platform of claim 3, wherein the processor is further configured to dynamically update the one or more decision areas based on the first plurality of traffic inputs and driving patterns of the plurality of users.

5. The platform of claim 4, wherein the processor is further configured to maintain a database of one or more of: the historical and real time decision areas, toll road geometry of the road network, toll locations on the road network, the plurality of first traffic inputs, the second plurality of toll inputs, and the third plurality of user associated inputs, and wherein the database is dynamically updated at a predefined time period.

6. The platform of claim 1, wherein the transceiver is further configured to receive historical incentives offered at the one or more decision areas, and the processor is further configured to determine the probability of the one or more users taking the at least toll road based on the historical incentives offered at the one or more decision areas.

7. The platform of claim 1, wherein the calculation of the incentives is further based on incentive inputs received from one or more tolling agencies, and current and historical revenues of the respective tolling agency.

8. The platform of claim 7, wherein the platform is further configured to:
determine an event of the one or more users selecting the at least one toll road based on the transmitted incentives;
transmit information associated with the event to the respective tolling agency;
verify the event with the respective tolling agency; and
perform a payment of toll prices including incentives to the respective tolling agency from the one or more accounts associated with the one or more users, based on the verification of the event.

9. The platform of claim 8, wherein the transceiver is further configured to transmit information associated with the incentives selected by the one or more users, to the respective tolling agency based on the determination of the event.

10. The platform of claim 8, wherein the transceiver is further configured to transmit information associated with the incentives offered to the one or more users and the calculated probability of the one or more users taking the at least one toll road to the respective tolling agency.

11. A method for providing incentives on toll prices to one or more users of a plurality of users, the method comprising:
receiving a first plurality of traffic inputs that comprises one or more of: historical traffic information of a road network, real time traffic information of the road network, information associated with real time events, and throughput of one or more toll roads on the road network;
receiving a second plurality of toll inputs that comprises one or more of: real time and historical toll prices for one or more toll roads on the road network, historical incentives on the toll prices offered at the one or more toll roads to the plurality of users;
receiving a third plurality of user inputs that comprises geo-locations of the plurality of users and one or more of: historical travel and driving patterns of the plurality of users on the road network, information on at least one of historical toll and incentives accepted by the plurality of users, user demographics, decision history of the plurality of users taking the one or more toll roads with or without incentives on toll prices, and an information of socio-economic status of the plurality of users;
identifying one or more decision areas in real time on the road network based on the first plurality of traffic inputs, wherein the decision areas are regions on the road network from where the plurality of users can enter at least one toll road of the one or more toll roads;
determining one or more users, of the plurality of users, approaching the one or more decision areas, based on the geo-locations of the plurality of users;
determining a probability of the one or more users taking the at least one toll road, based on the first plurality of traffic inputs, the second plurality of toll inputs, and the third plurality of user associated inputs;
calculating incentives on the toll prices to be offered to the one or more users to modify the probability of the one or more users taking the at least one toll road, wherein the incentives are calculated based on the first plurality of traffic inputs, the second plurality of the toll inputs, and the third plurality of user associated inputs; and
transmitting the calculated incentive to the one or more users when the one or more users are at the respective one or more decision areas.

12. The method of claim 11, wherein the incentives comprise at least one of increasing the toll prices, decreasing the toll prices, providing round trip discounts, and providing non-monetary benefits.

13. The method of claim 11, wherein identifying the one or more decision areas comprises:
determining traffic source and traffic sink based on the first plurality of traffic inputs;
determining a plurality of entrance points, exit points, and toll road locations from where traffic from the traffic source and traffic sink meet the one or more toll roads;
determining congestion levels at the plurality of entrance points, exit points and toll road locations based on the first plurality of traffic inputs; and
selecting one or more entrance points, exit points and toll road locations which fulfils a predetermined criteria, as the one or more decision areas.

14. The method of claim 13 further comprises dynamically updating the one or more decision areas based on the first plurality of traffic inputs and driving patterns of the plurality of users.

15. The method of claim 14 further comprises maintaining a database of one or more of: the historical and real time decision areas, toll road geometry of the road network, toll locations on the road network, the plurality of first traffic inputs, the second plurality of toll inputs, and the third plurality of user associated inputs, and wherein the database is dynamically updated at a predefined time period.

16. The method of claim 11 further comprises:
receiving historical incentives offered at the one or more decision areas, and
determining the probability of the one or more users taking the at least one toll road based on the historical incentives offered at the one or more decision areas.

17. The method of claim 16, wherein the calculation of the incentives is further based on incentive inputs received from one or more tolling agencies, and current and historical revenues of the respective tolling agency.

18. The method of claim 17 further comprises:
determining an event of the one or more users selecting the at least one toll road based on the transmitted incentives;
transmitting information associated with the event to the respective tolling agency;
verifying the event with the respective tolling agency; and
performing a payment of toll prices including incentives to the respective tolling agency from the one or more accounts associated with the one or more users, based on the verification of the event.

19. The method of claim 18 further comprises transmitting information associated with the incentives selected by the one or more users, to the respective tolling agency based on the determination of the event.

20. The method of claim 18 further comprises transmitting information associated with the incentives offered to the one or more users and the calculated probability of the one or more users taking the at least one toll road to the respective tolling agency.
